(19) United States
(12) Patent Application Publication
(10) Pub. No.: US 2010/0066326 A1
(43) Pub. Date: Mar. 18, 2010

(54) POWER REGULATOR

(76) Inventor: Hao-Chen HUANG, Taipei (TW)

Correspondence Address: PATENT PROSECUTION;O2MIRCO , INC., 3118 PATRICK HENRY DRIVE, SANTA CLARA, CA, 95054, US

(21) Appl. No.: 12/555,108

(22) Filed: Sep. 8, 2009

Related U.S. Application Data
(60) Provisional application No. 61/192,137, filed on Sep. 16, 2008.

(51) Int. Cl. G05F 1/10

(52) U.S. Cl. 323/282

(57) ABSTRACT

A power regulator for converting an input voltage to an output voltage includes a pass device and an error amplifier. The pass device receives the input voltage and provides the output voltage at an output terminal of the power regulator. The error amplifier coupled to the pass device includes a transistor. The transistor receives a reference signal and a feedback signal indicative of the output voltage, compares the feedback signal to the reference signal, and generates a control signal according to a result of the comparison to drive the pass device.

### RELATED APPLICATION

This application claims priority to U.S. Provisional Application No. 61/192,137, filed on Sep. 16, 2008, which is hereby incorporated by reference in its entirety.

### BACKGROUND

Some electronic devices or systems, such as cell phones, laptops, camera recorders and other mobile battery operated devices, may include low drop-out (LDO) power regulators to provide relatively precise and stable DC voltages.

The LDO power regulator including a pass device, an error amplifier, and a feedback circuit can convert an input voltage to an output voltage at a predetermined level to serve as a power supply. Typically, the error amplifier includes a differential amplifier that is driven by a common signal. For example, the differential amplifier can be a TL431 amplifier or the amplifier in a μA7805 regulator manufactured by Texas Instrument®. However, the conventional differential amplifier usually has a relatively complex configuration and a relatively high cost, and thus the cost of the LDO power regulator is increased.

### SUMMARY

In one embodiment, a power regulator for converting an input voltage to an output voltage includes a pass device and an error amplifier. The pass device receives the input voltage and provides the output voltage at an output terminal of the power regulator. The error amplifier coupled to the pass device includes a transistor. The transistor receives a reference signal and a feedback signal indicative of the output voltage, compares the feedback signal to the reference signal, and generates a control signal according to a result of the comparison to drive the pass device.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows a power regulator according to one embodiment of the present invention.

FIG. 2 shows a schematic diagram of an error amplifier according to one embodiment of the present invention.

FIG. 3 shows a schematic diagram of a power regulator according to one embodiment of the present invention.

FIG. 4 shows a block diagram of an electronic system according to one embodiment of the present invention.

FIG. 5 shows a flowchart of a method for converting an input voltage to an output voltage according to one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments in accordance with the present invention provide a power regulator which can have a relatively low cost. Advantageously, an error amplifier in the power regulator employs reduced number of components compared to the error amplifier in the conventional power regulator, in one embodiment.

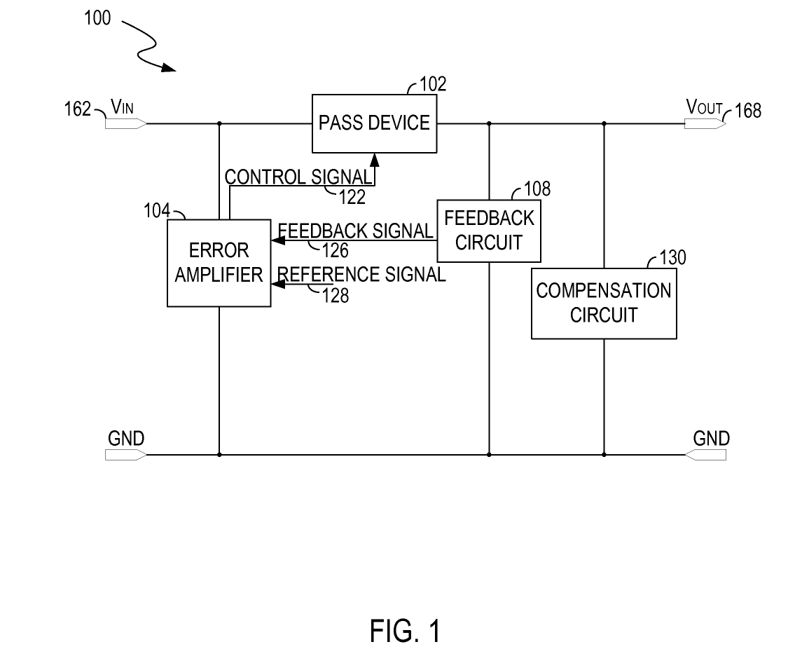

FIG. 1 shows a power regulator 100 according to one embodiment of the present invention. The power regulator 100, e.g., a low drop-out voltage regulator, can convert an input voltage V_{IN} to an output voltage V_{OUT}. In the example of FIG. 1, the power regulator 100 includes a pass device 102, an error amplifier 104, and a feedback circuit 108. The power regulator 100 can further include a compensation circuit 130.

The pass device 102 is coupled to an input terminal 162 of the regulator 100 for receiving the input voltage V_{IN} at the input terminal 162 and for providing an output voltage V_{OUT} at an output terminal 168 of the regulator 100. The output voltage V_{OUT} can be used to power an external load (not shown in FIG. 1). The pass device 102 is an active device that can be controlled to provide the output voltage V_{OUT}. The pass device 102 can include one or more power transistors.

The feedback circuit 108 is coupled to the output terminal 168 for generating a feedback signal 126 indicative of the output voltage V_{OUT}. The error amplifier 104 coupled to the pass device 102 compares the feedback signal 126 to a reference signal 128, and generates a control signal 122 according to a result of the comparison to drive the pass device 102. The control signal 122 can control a conductance of the pass device 102. For example, the control signal 122 can control the pass device 102 linearly to vary the on-resistance of the pass device 102. As a result, a current flowing through the pass device 102 can be varied to adjust the output voltage V_{OUT}. The reference signal 128 can be provided by a reference signal circuit (not shown in FIG. 1) in the power regulator 100 or an external device. In the example of FIG. 1, the error amplifier 104 is powered by the input voltage V_{IN}. Alternatively, the error amplifier 104 can be powered by another power supply (not shown in FIG. 1). The feedback circuit 108, the error amplifier 104, and the pass device 102 together can constitute a negative feedback loop to produce a relatively precise and stable output voltage V_{OUT} at the output terminal 168.

The compensation circuit 130 can be used to compensate the output voltage V_{OUT} variation, e.g., to smooth the output voltage V_{OUT}. The output voltage V_{OUT} variation can be caused by the characteristic changes of the pass device 102, which is due to the variations of the input voltage V_{IN}.

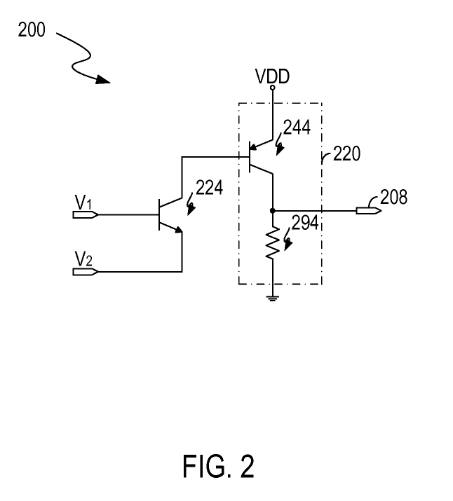

FIG. 2 shows an error amplifier 200 according to one embodiment of the present invention. The error amplifier 200 compares input voltages V₁ and V₂ and generates an amplified error signal at an output 208. In the example of FIG. 2, the error amplifier 200 includes a transistor 224 and a driver 220. In the example of FIG. 2, the driver 220 includes a transistor 244 and a resistor 294. The base of the transistor 244 is coupled to the collector of the transistor 224. The resistor 294 couples the collector of the transistor 244 to ground. The emitter of the transistor 244 is coupled to a power supply VDD. A voltage is generated at the output 208 between the transistor 244 and the resistor 294.

The base and the emitter of the transistor 224 receive the input voltages V₁ and V₂, respectively. A collector current of the transistor 224 is generated according to a voltage difference between the input voltages V₁ and V₂, and is delivered to the driver 220. In the example FIG. 2, the collector current of the transistor 224 is provided to the base of the transistor 244. Thus, the amplified error signal indicative of the difference between the input voltages V₁ and V₂ can be generated at the output 208 accordingly.

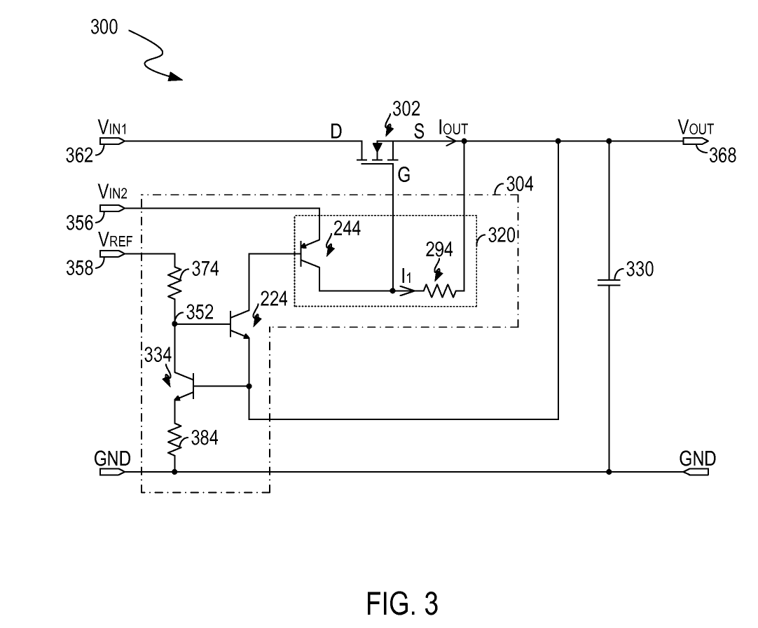

FIG. 3 shows a schematic diagram of a power regulator 300 according to one embodiment of the present invention. Elements labeled the same as in FIG. 2 have similar functions. In the example of FIG. 3, the power regulator 300 includes a pass device, e.g., a field-effect transistor (FET) 302, an error amplifier 304, and a capacitor 330. In the example of FIG. 3, the error amplifier 304 includes the transistor 224, a transistor 334, resistors 374 and 384, and a driver 320. The capacitor 330 is coupled to the output terminal 368 and serves as a compensation circuit for smoothing the output voltage V_{OUT} so as to improve the stability of the power regulator 300, in one embodiment.

A first power supply voltage V_{IN1} is supplied to the FET 302 at an input terminal 362 of the power regulator 300. An output voltage V_{OUT} is provided by the FET 302 at an output terminal 368 of the power regulator 300. A second power supply voltage V_{IN2} is supplied to the error amplifier 304 at an input terminal 356 of the power regulator 300. A reference voltage V_{REF} is provided to the error amplifier 304 at an input terminal 358 of the power regulator 300. In one embodiment, the reference voltage V_{REF} can be provided by a reference voltage circuit (not shown in FIG. 3) in the power regulator 300. In one embodiment, the input terminal 356 is coupled to the input terminal 362 for receiving a power supply voltage. In another embodiment, the input terminal 356 is coupled to the input terminal 358 for receiving a power supply voltage.

The resistor 374, the transistor 334, and the resistor 384 are coupled to each other in series. A voltage is generated at a node 352 between the resistor 374 and the transistor 334, and is input to the base of the transistor 224, in one embodiment. The emitter of the transistor 224 is coupled to the output terminal 368 of the power regulator 300 for sensing the output voltage V_{OUT}. In other words, the emitter of the transistor 224 receives a feedback signal indicative of the output voltage V_{OUT}, in one embodiment. In the example of FIG. 3, the emitter of the transistor 224 is directly coupled to the output terminal 368. Alternatively, a voltage divider (not shown in FIG. 3) can be used to generate a scaled voltage according to the output voltage V_{OUT} and to provide the scaled voltage to the emitter of the transistor 224. Thus, a voltage at the base of the transistor 224 can indicate the reference voltage V_{REF}, and a voltage at the emitter of the transistor 224 can indicate the output voltage V_{OUT}.

Advantageously, the transistor 224 in the error amplifier 304 compares the feedback signal indicative of the output voltage V_{OUT} to the reference voltage V_{REF}, and generates a control signal according to a result of the comparison to drive the FET 302. More specifically, the transistor 224 can generate a collector current according to the voltage difference between the voltage at the base and the voltage at the emitter, in one embodiment. The driver 320 receives the collector current of the transistor 224 and generates a control signal to control a conductance of the FET 302 in response to the collector current of the transistor 224.

Therefore, the error amplifier 304 may only employ one transistor, e.g., the transistor 224, to compare the feedback signal indicative of the output voltage V_{OUT} to the reference signal V_{REF}. Furthermore, as shown in the example of FIG. 3, three transistors are included in the error amplifier 304. In applications, some cost-effective transistors can be used, such as MMBT3904 NPN or MMBT3906 PNP transistors. Thus, compared to the conventional differential amplifiers, the error amplifier 304 has a relatively cost-effective configuration.

In the example of FIG. 3, the driver 320 includes the transistor 244 and the resistor 294. The emitter of the transistor 244 is coupled to the input terminal 356 of the power regulator 300 for receiving the second power supply voltage V_{IN2}. The base of the transistor 244 is coupled to the collector of the transistor 224. The collector of the transistor 244 is coupled to the resistor 294. The base of the transistor 244 receives the collector current of the transistor 224. Thus, a collector current of the transistor 244 is generated accordingly. The current I₁ flowing through the resistor 294 generates a voltage drop across the resistor 294. The resistor 294 is coupled between the gate and the source of the FET 302. Thus, the driver 320 generates a control signal to control a gate-source voltage of the FET 302. In other words, the voltage drop across the resistor 294 controls the conductance of the FET 302 to provide the output voltage V_{OUT}. The voltage drop across the resistor 294 can adjust the on-resistance of the FET 302, thus can control the current I_{OUT} flowing through the FET 302 and the output voltage V_{OUT}.

The power regulator 300 can generate the output voltage V_{OUT} at a predetermined level or range. For example, when the output voltage V_{OUT} is less than the predetermined level (e.g., when the voltage at the emitter of the transistor 224 is less than the voltage at the base of the transistor 224), the collector current of the transistor 224 increases. Thus, the base current of the transistor 244 increases. Accordingly, the collector current of the transistor 244 increases and the current I₁ flowing through the resistor 294 increases. Thus, the voltage drop across the resistor 294 increases and the gate-to-source voltage of the FET 302 increases. As a result, the output current I_{OUT} flowing through the FET 302 increases and the output voltage V_{OUT} increases.

On the contrary, when the output voltage V_{OUT} is greater than the predetermined level (e.g., when the voltage at the emitter of the transistor 224 is greater than the voltage at the base of the transistor 224), the collector current of the transistor 224 decreases. Thus, the collector current of the transistor 244 decreases and the current I₁ decreases. Accordingly, the voltage drop across the resistor 294 decreases and the gate-source voltage of the FET 302 decreases. As a result, the output current I_{OUT} flowing through the FET 302 decreases and the output voltage V_{OUT} decreases.

The transistor 334 in the error amplifier 304 can be used to compensate temperature variations, in one embodiment. During operation, the power regulator 300 can operate at a certain temperature range. The transistor 334 can help maintain the output voltage V_{OUT} at the predetermined level if the temperature of the power regulator 300 varies. For example, if the temperature rises, the base-to-emitter voltage V_{be} of the transistor 224 decreases. The output voltage V_{OUT} increases and the base current of the transistor 334 increases accordingly. Thus, the collector-to-emitter voltage V_{ce} of the transistor 334 decreases. The voltage at the node 352 decreases. In one embodiment, the voltage at the node 352 is equal to a summation of the base-to-emitter voltage V_{be} of the transistor 224 and the output voltage V_{OUT}. Advantageously, the collector-to-emitter voltage V_{ce} of the transistor 334 varies according to the temperature to compensate a variation of the base-to-emitter voltage V_{be} of the transistor 224. As such, the output voltage V_{OUT} can still be maintained at the predetermined level or range if the temperature varies.

By similar rational, a diode (not shown in FIG. 3) can be used to replace of the transistor 334 to compensate the temperature variations. In this embodiment, the anode of the diode is coupled to the node 352 and the cathode of the diode is coupled to the resistor 384.

The power regulator 300 can be used in applications which require relatively small differences between an input power supply voltage and an output voltage, such as battery-powered systems and switching-mode power supply (SMPS).

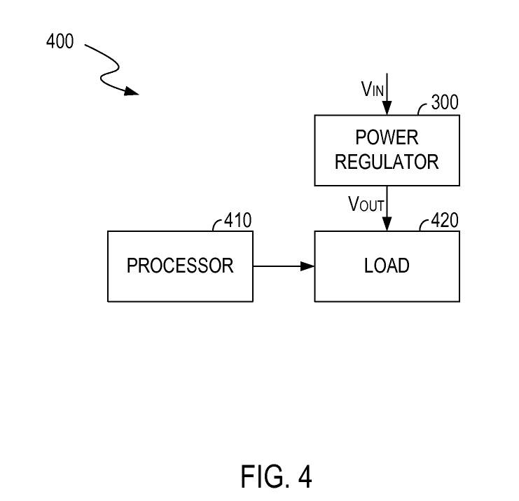

FIG. 4 shows an electronic system 400 according to one embodiment of the present invention. In the example of FIG. 4, the electronic system 400 includes a processor 410, a load 420 coupled to the processor 410, and a power regulator 300. The power regulator 300 in FIG. 4 is similar to the power regulator 300 in FIG. 3. The electronic system 400 can be a computer, a personal digital assistance (PDA), a mobile phone, or the like.

The processor 410 controls the load 420. For example, the processor 410 can execute computer-executable instructions to enable the load 420 to perform various functions. The processor 410 can be, but is not limited to, a central processing unit (CPU). The load 420 can be, but is not limited to, a chip, a memory, or a storage card. The power regulator 300 coupled to the load 420 can convert an input voltage V_{IN} to an output voltage V_{OUT}, and can power the load 420 by the output voltage V_{OUT}.

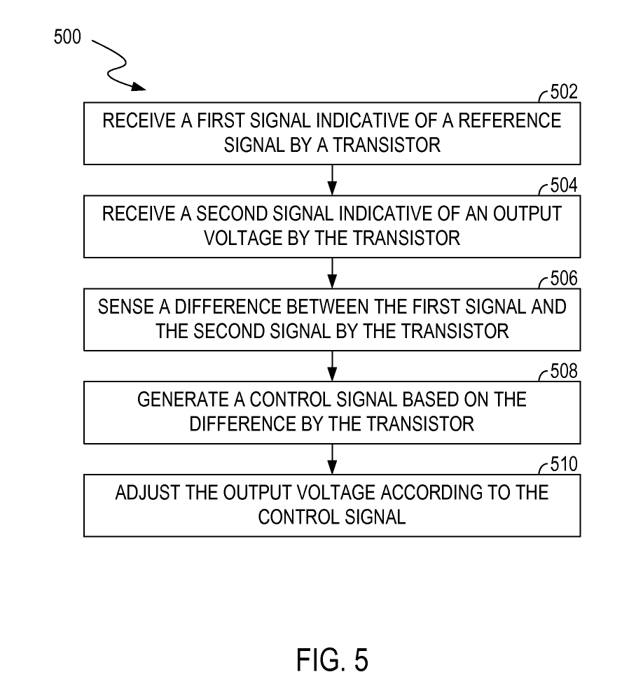

FIG. 5 shows a flowchart 500 of a method for converting an input voltage to an output voltage according to one embodiment of the present invention. FIG. 5 is described in combination with FIG. 3. Although specific steps are disclosed in FIG. 5, such steps are examples. That is, the present invention is well suited to performing various other steps or variations of the steps recited in FIG. 5.

In block 502, the transistor 224 in the error amplifier 304 receives a first signal indicative of the reference voltage V_{REF}. In one embodiment, resistor 374, the transistor 334, and the resistor 384 are coupled to each other in series. The reference voltage V_{REF} is provided to the resistor 374. The resistor 384 is coupled to ground. The voltage at the node 352 indicating the reference voltage V_{REF} is input to the base of the transistor 224, in one embodiment.

In block 504, the transistor 224 receives a second signal indicative of the output voltage V_{OUT}. In one embodiment, the emitter of the transistor 224 receives the second signal. In the example of FIG. 3, the emitter of the transistor 224 is directly coupled to the output terminal 368. Alternatively, a voltage divider (not shown in FIG. 3) can be used to provide a scaled voltage according to the output voltage V_{OUT} and to provide the scaled voltage to the emitter of the transistor 224.

In block 506, a voltage difference between the first signal indicative of the reference voltage V_{REF} and the second signal indicative of the output voltage V_{OUT} is sensed by the transistor 224. In the example of FIG. 3, the base-to-emitter voltage V_{be} of the transistor 224 indicates the voltage difference between the first signal and the second signal.

In block 508, a control signal, e.g., the collector current of the transistor 224, is generated by the transistor 224 based on the difference between the first signal and the second signal.

In block 510, the output voltage V_{OUT} is adjusted according to the control signal generated by the transistor 224. In one embodiment, the driver 320 generates a control signal to control the conductance of the FET 302 in response to the control signal generated by the transistor 224. In the example of FIG. 3, the base of the transistor 244 in the driver 320 receives the collector current of the transistor 224. Accordingly, a collector current of the transistor 244 is generated. Thus, the voltage drop across the resistor 294 in the driver 320 can be generated to control the gate-source voltage of the FET 302. As such, the output voltage V_{OUT} can be adjusted according to the collector current of the transistor 224.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A power regulator for converting an input voltage to an output voltage, said power regulator comprising:
a pass device operable for receiving said input voltage and providing said output voltage at an output terminal of said power regulator; and
an error amplifier coupled to said pass device, said error amplifier comprising:
a first transistor operable for receiving a reference signal and a feedback signal indicative of said output voltage, for comparing said feedback signal to said reference signal, and for generating a first control signal according to a result of said comparison to drive said pass device.

2. The power regulator of claim 1, wherein said error amplifier further comprises a driver coupled to said first transistor and said pass device, and operable for generating a second control signal to control a conductance of said pass device in response to said first control signal.

3. The power regulator of claim 2, wherein said pass device comprises a second transistor, and wherein said driver generates said second control signal to control a gate-source voltage of said second transistor.

4. The power regulator of claim 2, wherein said driver comprises:
a second transistor coupled to said first transistor and operable for receiving said first control signal; and
a resistor coupled to said second transistor and said pass device and for providing said second control signal to control said conductance of said pass device.

5. The power regulator of claim 1, wherein said error amplifier further comprises a second transistor coupled to said first transistor and operable for maintaining said output voltage at a predetermined level if the temperature of said power regulator varies.

6. The power regulator of claim 5, wherein a collector-to-emitter voltage of said second transistor varies according to the temperature of said power regulator to compensate a variation of a base-to-emitter voltage of said first transistor.

7. The power regulator of claim 1, wherein said reference signal and said feedback signal are provided to a base and an emitter of said first transistor respectively, and wherein said first control signal is generated at a collector of said first transistor.

8. The power regulator of claim 1, wherein a collector current of said first transistor varies according to a difference between said feedback signal and said reference signal, and wherein said collector current is configured to control a conductance of said pass device.

9. An electronic system comprising:
a load;
a processor coupled to said load and operable for controlling said load; and
a power regulator coupled to said load and operable for powering said load by an output voltage, said power regulator comprising:
a pass device operable for receiving an input voltage and providing said output voltage; and
a first transistor operable for receiving a reference signal and a feedback signal indicative of said output voltage, for comparing said feedback signal to said reference signal, and for generating a first control signal according to a result of said comparison to drive said pass device.

10. The electronic system of claim 9, wherein said power regulator further comprises a driver coupled to said first transistor and said pass device and operable for generating a second control signal to control a conductance of said pass device in response to said first control signal.

11. The electronic system of claim 10, wherein said pass device comprises a second transistor, and wherein said driver generates said second control signal to control a gate-source voltage of said second transistor.

12. The electronic system of claim 9, wherein said power regulator further comprises:
a second transistor coupled to said first transistor and operable for maintaining said output voltage at a predetermined level if the temperature of said power regulator varies.

13. The electronic system of claim 12, wherein a collector-to-emitter voltage of said second transistor varies according to the temperature of said power regulator to compensate a variation of a base-to-emitter voltage of said first transistor.

14. The electronic system of claim 9, wherein said reference signal and said feedback signal are provided to a base and an emitter of said first transistor respectively, and wherein said first control signal is generated at a collector of said first transistor.

15. The electronic system of claim 9, wherein a collector current of said first transistor varies according to a difference between said feedback signal and said reference signal, and wherein said collector current is configured to control a conductance of said pass device.

16. A method for converting an input voltage to an output voltage, said method comprising:
receiving a first signal indicative of a reference signal by a transistor;
receiving a second signal indicative of said output voltage by said transistor;
sensing a difference between said first signal and said second signal by said transistor;
generating a first control signal based on said difference by said transistor; and
adjusting said output voltage according to said first control signal.

17. The method of claim 16, further comprising:
providing said first signal and said second signal to a base and an emitter of said transistor respectively; and
generating said first control signal at a collector of said transistor.

18. The method of claim 16, further comprising:
varying a collector current of said transistor according to a difference between said feedback signal and said reference signal, and
controlling a conductance of a pass device according to said collector current.

19. The method of claim 16, further comprising:
receiving said input voltage by a pass device;
generating a second control signal to control a conductance of said pass device in response to said first control signal; and
providing said output voltage by said pass device.

20. The method of claim 16, further comprising:
maintaining said output voltage at a predetermined level if the temperature of a regulator that converts said input voltage to said output voltage varies.
